(19) United States
(12) Patent Application Publication
(10) Pub. No.: US 2009/0026956 A1
(43) Pub. Date: Jan. 29, 2009

(54) COILED COIL ELECTRODE DESIGN FOR HIGH PRESSURE SODIUM LAMPS

(75) Inventors: Janos Sneider, Fot (HU); Zoltan Toth, Budapest (HU); Mihaly Lipcsei, Budapest (HU)

Correspondence Address: FAY SHARPE LLP, 1100 SUPERIOR AVENUE, SEVENTH FLOOR, CLEVELAND, OH, 44114, US

(73) Assignee: General Electric Company, Schenectady, NY (US)

(21) Appl. No.: 12/147,979

(22) Filed: Jun. 27, 2008

Related U.S. Application Data
(60) Provisional application No. 60/952,371, filed on Jul. 27, 2007.

(51) Int. Cl. H01J 17/04; H01J 9/00; H01J 65/00

(52) U.S. Cl. 313/631; 445/26; 313/234

(57) ABSTRACT

A high pressure sodium discharge lamp includes an arc tube which encloses a discharge sustaining fill which comprises sodium. Electrodes extend into the fill for generating an arc discharge in the fill during operation of the lamp. At least one of the electrodes includes a coiled coil which supports an emitter material thereon.

This application claims the priority benefit of U.S. Provisional Application Ser. No. 60/952,371, filed Jul. 27, 2007, the disclosure of which is incorporated herein by reference in its entirety.

### BACKGROUND OF THE INVENTION

The exemplary embodiment relates to high pressure sodium (HPS) lamps and in particular to a coiled coil electrode for HPS lamps.

Many designs for high intensity discharge (HID) lamps, and in particular high pressure sodium (HPS) lamps, are known in the art. Sodium lamps of this type generally include an arc discharge chamber or “arc tube,” surrounded by a protective envelope. The discharge chamber is typically polycrystalline alumina (PCA) or a single crystal alumina (sapphire) and is filled with a mixture of gases, which form an arc discharge. The fill generally includes sodium and mercury and an inert starting gas such as xenon. The sodium and mercury components of the fill material are primarily responsible for the light output characteristics of the lamp. The amalgam of these two components tends to condense in the coldest spot of the arc tube.

Existing HPS lamps often employ double coiled wire electrodes, in which the electrode includes two layers of wire. The electrode is coated with an electron emissive material, such as barium tungsten oxide. In monolithic lamps, the arc tube is fabricated as a unitary body with a single end cap or “bushing” sintered to the body at one end. Such lamps are often constructed such that the arc tube has a temperature profile, in operation, in which the temperature of the arc tube wall increases away from the sintered end of the lamp. Some current monolithic arc tube designs with a double coiled electrode tend to be more sensitive to blackening and arc tube heat profile change because the cold spot of the arc tube wall is closer to the blackening zone.

Blackening tends to impact lumen maintenance of the lamp due to the covering effect of the blackening layer and also impacts the stability of the burning voltage (BV), due to the changed thermal profile.

The temperature of the cold spot is defined by several factors, including the conducted heat (which is a function of the construction of the ceramic tube wall and electrode shank), the convected heat (due in part to xenon and mercury-sodium vapor turbulence), the radiated heat (largely due to the electrode body and the arc), and the heat reflection factor (due in part to the Nb-band positioned at the hotter end of the lamp and any blackening).

### BRIEF DESCRIPTION OF THE INVENTION

In accordance with one aspect of the exemplary embodiment, a high pressure sodium discharge lamp includes an arc tube which encloses a discharge sustaining fill which comprises sodium. Electrodes extend into the fill for generating an arc discharge in the fill during operation of the lamp. At least one of the electrodes includes a coiled coil which supports an emitter material thereon.

In accordance with another aspect of the exemplary embodiment, a method of forming a high pressure discharge lamp includes forming a first coil structure of an electrode by coiling an overwind wire around a base wire, forming a second coil structure of the electrode by coiling the first coil structure around a shank, coating the electrode with an emitter material, inserting the electrode with a second electrode into an arc tube, and sealing a discharge sustaining fill comprising sodium in the arc tube.

In another aspect, an electrode comprises a cylindrical tungsten shank having a diameter of 0.5-2 mm for coupling to an associated current source. A coiled coil is provided on the tungsten shank, the coiled coil having a first coil structure formed by coiling an electrically conductive overwind wire around a base wire and a second coil structure formed by coiling the first coil structure around the shank. An emitter material is supported on the coiled coil.

### BRIEF DESCRIPTION OF THE DRAWINGS

FIG. 1 illustrates an exemplary high pressure sodium lamp in accordance with one aspect of the exemplary embodiment;

FIG. 2 illustrates an arc tube for the lamp of FIG. 1;

FIG. 3 is a perspective view in partial cross section of an exemplary coiled coil electrode for the arc tube of FIG. 2;

FIG. 4 is a perspective view of the coiled coil electrode of FIG. 3;

FIG. 5 illustrates an end view of the coiled coil of the electrode of FIG. 3;

FIG. 6 illustrates the shadow effect of a conventional electrode;

FIG. 7 illustrates the electrode shadow outline of the exemplary electrode of FIG. 3;

FIG. 8 illustrates a first step in the formation of the electrode of FIGS. 3-5 and 7;

FIG. 9 illustrates a second step in the formation of the electrode of FIGS. 3-5 and 7;

FIG. 10 illustrates an exemplary plot of efficacy (lumens/watt) vs. lamp voltage for conventional lamps and exemplary lamps at 100 hrs and after operation for 6000 hours;

FIG. 11 shows lamp voltage maintenance for exemplary lamps over 14000 hours and conventional lamps over 6000 hrs;

FIG. 12 shows lamp lumen maintenance for exemplary lamps over 12,000 hours; and

FIG. 13 is a plot which shows lumens/watt over time for a 70 watt lamp with a standard double coiled electrode (curve A) and a 70 watt lamp according to the exemplary embodiment with a coiled coil electrode of the type shown in FIG. 3 (curve B).

### DETAILED DESCRIPTION OF THE INVENTION

Aspects of the exemplary embodiment relate to a high pressure sodium lamp comprising at least one (and generally two) coiled coil electrode. The exemplary lamp is found to improve lamp efficiency by reducing electrode losses, as compared with a conventional electrode structure of a high pressure sodium (HPS) lamp.

In various aspects, an electrode coil body is coiled with a primary coiled wire, to retain more electron emissive material (E-mix) in a lighter weight electrode.

In various aspects, end blackening is reduced by having a large active emitter mix area of a slimmer and lighter design for a coiled coil body while retaining a solid mechanical structure.

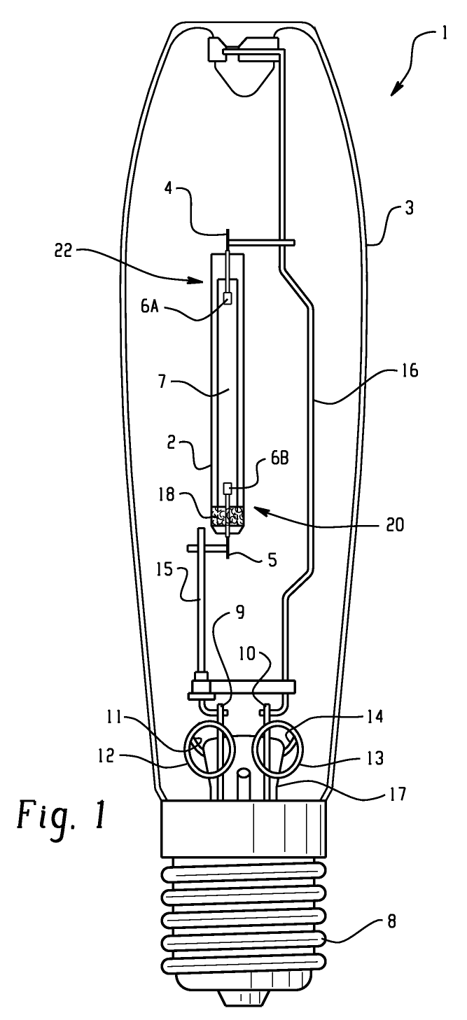

Referring now to the drawings, which illustrate an exemplary embodiment only and are not intended to limit same, FIG. 1 shows a high pressure sodium lamp 1, which includes a high pressure alumina discharge vapor arc chamber in the form of a monolithic arc tube 2 disposed within a transparent outer vitreous envelope 3. Arc tube 2 contains, under pressure, an arc producing medium or “fill” 7 comprising sodium, optionally mercury, and a starting gas, such as xenon or other inert gas. Electrical niobium lead wires 4 and 5 allow coupling of electrical energy to tungsten electrodes 6A, 6B, supporting thereon an electron emissive material, and disposed within the discharge chamber 2 so as to enable excitation of the fill 7 contained therein. Sealing frit (not shown) bonds the lead wires 4 and 5 to the alumina of the arc chamber 2 at either end. Sealing is first done at lead wire 4. Sealing at lead wire 5 is accomplished using an alumina bushing feed through assembly 7A. Lead wires 4 and 5 are electrically connected to the threaded screw base 8 by means of support members 15 and 16, and in lead wires 9 and 10, which extend through stem 17.

The xenon fill gas may have a cold fill pressure from about 10 to 500 torr, e.g., about 20-200 torr. During operation, the xenon pressure may increase to about eight times the cold fill pressure. The partial pressure of the sodium ranges from 30 to 1000 torr during operation, e.g., about 70 to 150 torr for high efficacy. The amount of sodium in the lamp may be about 5-30 mg, e.g., about 12 mg for a 70 watt lamp, and (other than in a mercury-free lamp) the ratio of Na/Hg in the amalgam may be about 10-20%.

Initiation of an arc discharge between electrodes 6A, 6B generally requires a starting voltage pulse of about 1.5 to 4.5 kV. This ionizes the starting gas, initiating current flow which raises the temperature in the arc tube 2 and vaporizes the sodium and mercury contained therein. An arc discharge is then sustained by the ionized vapor and the operating voltage stabilizes.

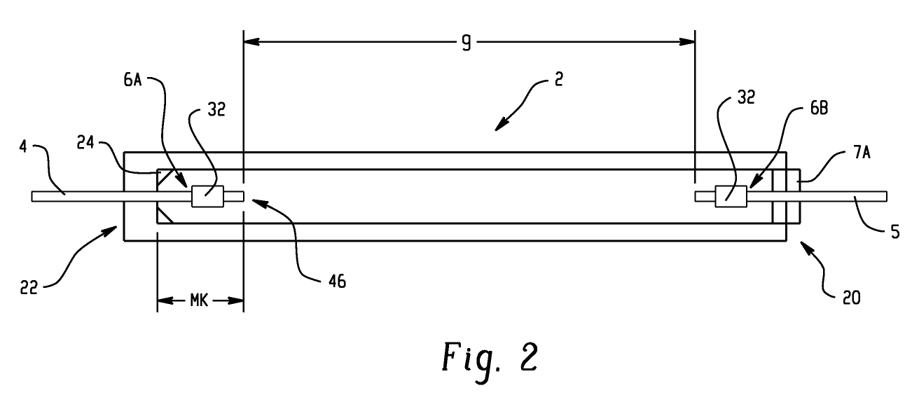

The lamp 1 may also include a niobium (Nb) foil heat-reflective band 18, which maintains a higher operation of temperature at the end 20 of arc chamber 2 toward the lamp base as compared to the opposite end 22. As a result, the unvaporized amounts of metallic dose components, i.e., a sodium and mercury amalgam 24, reside at the colder end 22 of arc chamber 2 during operation as shown in FIG. 2. The lamp 1 is designed to prohibit contact of liquid sodium with the sealing frit to avoid life-limiting reactions and the possibility of rectification (high ballast current) during startup.

In one aspect of the exemplary embodiment, fill 7 contained within the arc tube 2 consists of sodium, mercury, and a starting gas, such as xenon. Other acceptable starting gases may include any non-reactive ionizable gas such as a noble gas sufficient to cause the establishment of a gaseous arc discharge. In one embodiment, the metallic dose (at the monolithic alumina corner at end 22) is introduced into the monolithic arc tube body following sealing of the electrode 6A to the body. The xenon starting gas is subsequently sealed in the arc tube by high temperature sealing of the bushing 7A and electrode 6B to the open end of the body in a xenon atmosphere.

While FIG. 1 shows a single-ended, monolithic lamp, other lamp types are also contemplated, such as double ended lamps and non-monolithic lamps (formed with two bushings rather than one).

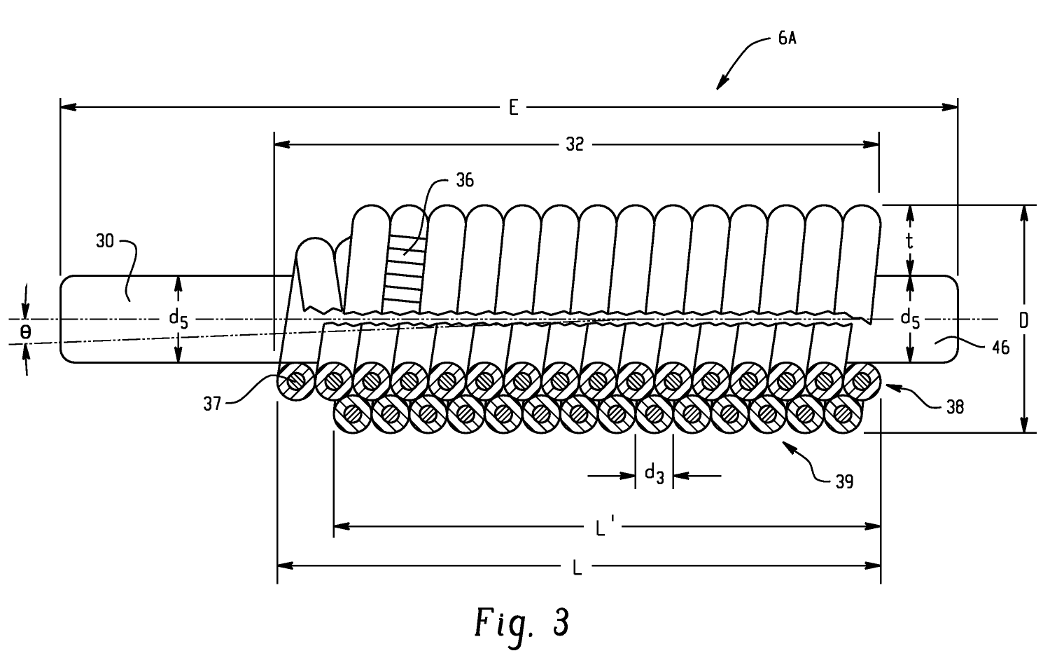

The exemplary discharge chamber 2 is formed primarily of alumina, optionally doped with amounts of other ceramic oxides, such as magnesium oxide. The main body of the discharge chamber can be constructed by any means known to those skilled in the art such as die pressing a mixture of ceramic powder in a binder into a solid cylinder. Alternatively, the mixture can be extruded or injection molded. Techniques for forming the discharge tube are known, as described, for example, in U.S. Pat. No. 6,639,362 to Scott, et al. With reference to FIGS. 3-5 and 7-9, the electrodes 6A, 6B each include a shank in the form of a tungsten rod 30 of diameter d with a coiled coil 32 therearound of diameter D and thickness t (outer diameter minus inner diameter). The coiled coil is coated with an electron emissive material (emitter material) 34 (FIG. 9) to form an emissive reservoir 35. The shank 30 is generally axially arranged in the arc tube 2 and is electrically connected with lead in connectors 4, 5. The shanks 30 of the electrodes 6A, 6B define an arc gap g therebetween (FIG. 2).

Suitable emitter materials are barium-containing oxides and mixed metal oxides, such as barium calcium tungstate, barium strontium tungstate, barium yttrium tungstate, barium tungstate, barium aluminate, or the like. Other suitable emissive materials include metal oxides in which the oxide is selected from the group consisting of oxides of La, Ce, Pr, Nd, Pm, Sm, Eu, Gd, Tb, Dy, Ho, Er, Tm, Yb, Lu, Y, Sc, Hf, Zr, and combinations thereof. It is to be appreciated that, the emitter materials are not limited to those listed. The metal oxide is present in a quantity that ranges from about 20% to 100% by weight of the total emissive material mixture. The emissive material 34 is operable to emit electrons in the fill under steady state operating conditions.

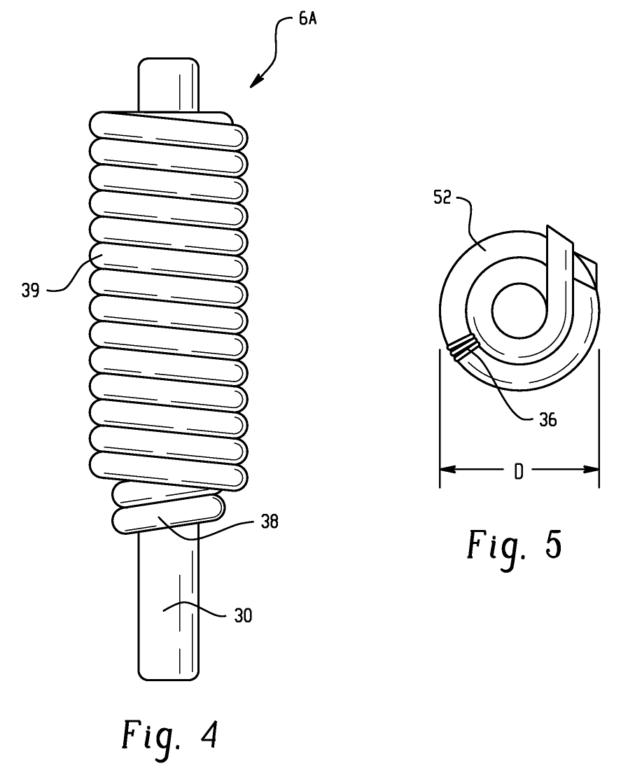

As shown in partial section in FIG. 3, the coiled coil 32 has a primary coil structure and a secondary coil structure. The primary coil structure is formed by winding an overwind wire 36 around a base wire 37. The secondary coil is formed by winding the primary coil structure around the shank 30. As shown in FIG. 4, the primary coil structure may be wound around to the coil to form two (or more) overlapping layers 38, 39. The two windings 38, 39 may have an opposite pitch angle θ (e.g., up to about 1.5°) and the same number of turns per inch (TPI) (FIG. 3). Layers 38, 39 forming the secondary coil structure may be substantially coextensive, as shown in FIG. 3.

In one embodiment, the base wire 37 has a diameter d₁ of about 0.05-0.2 mm, e.g., about 0.1 mm and the overwind wire 36 may have a smaller diameter than the base wire, e.g., a diameter d₂ of about 0.01-0.1 mm, e.g., about 0.03-0.04 mm. The resulting primary coil structure therefore has a diameter d₃ which is approximately: d₃=(2×d₂)+d₁, e.g., about 0.07-0.4 mm, e.g., about 0.2 mm. The secondary coil structure, when double wound on a tungsten shank 30 of about 0.7 mm, may thus have a diameter D of about 1.36 mm, as shown in FIGS. 3 and 5.

In the exemplary embodiment, the overwind wire 36 has a thickness (diameter) d₂ of 0.0346 mm and is tightly wound around a base wire 37 of diameter d₁ of 0.1056 mm, so that in the primary coil structure, the TPI (turns per inch) of the overwind wire 36 on the base wire 37 may thus be at or close to the maximum theoretical value (a TPI of 419.86 in the example). For example, the TPI may be at least 90% or at least 95% of the theoretical maximum. A lower TPI is also contemplated, such as a TPI which is at least 60% or 70% of the theoretical maximum, which in the present example, would mean a TPI of about 250 or higher. Similarly, the windings may be tightly spaced in each layer 38, 39 of the second coil structure, to provide a TPI in the second coil structure at or close to the theoretical maximum (a TPI of 145.29 in the example), although a lower TPI may be used for the secondary coil structure, such as a TPI of at least about 60% or 70% of the theoretical maximum, which in the present example would mean a TPI of about 80 or higher.

For some applications, it is desirable to achieve the maximum loading of emitter material which can be activated effectively. In one embodiment, the exemplary electrode 6A, 6B and lamp formed therefrom may support at least about 20%, e.g., about 50% more emitter material than in a conventional double coiled lamp of the same coil length L and same electrode diameter D. Since the life of the lamp is dependent, to some degree, on the amount of emitter material, the added amount of emitter which can be supported on the same diameter of coil can result in an increased life of the lamp. The diameter of conventional arc tubes for low wattage HPS lamps places a constraint on the electrode diameter. The exemplary electrode can have a slimmer diameter and yet hold the same amount of emitter mix as a conventional coil. As a result, the lamp life may be similar to that of a higher wattage (larger diameter) lamp.

In general, however, it may be desirable to minimize the diameter D. Thus, a coil 32 can be formed with the same or smaller diameter D than a conventional double coil electrode while supporting at least as much or more emitter material. In one embodiment, the coiled coil electrode 6A, 6B may have approximately the same amount of emitter material as that of a conventional lamp electrode while having a diameter D which is about 80% or less, e.g., about 50% of the diameter of the conventional double coil electrode.

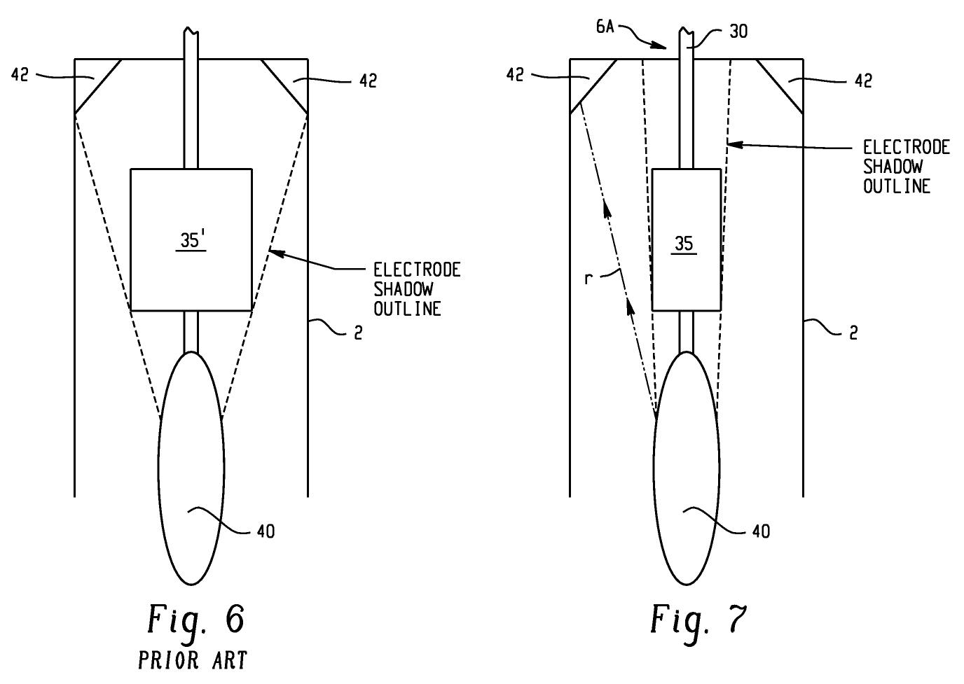

As shown by comparing FIGS. 6 and 7, another advantage of a lamp with an emitter reservoir 35 of narrow diameter is that the light (as indicated by exemplary ray r) can travel directly from the arc 40 to the amalgam 24 in the cold spot (FIG. 7), as compared with the emitter reservoir 35′ of a conventional double wound coil electrode (FIG. 6), where, due to the diameter of the reservoir, the electrode shields all or most of the condensed material 42 from the direct light.

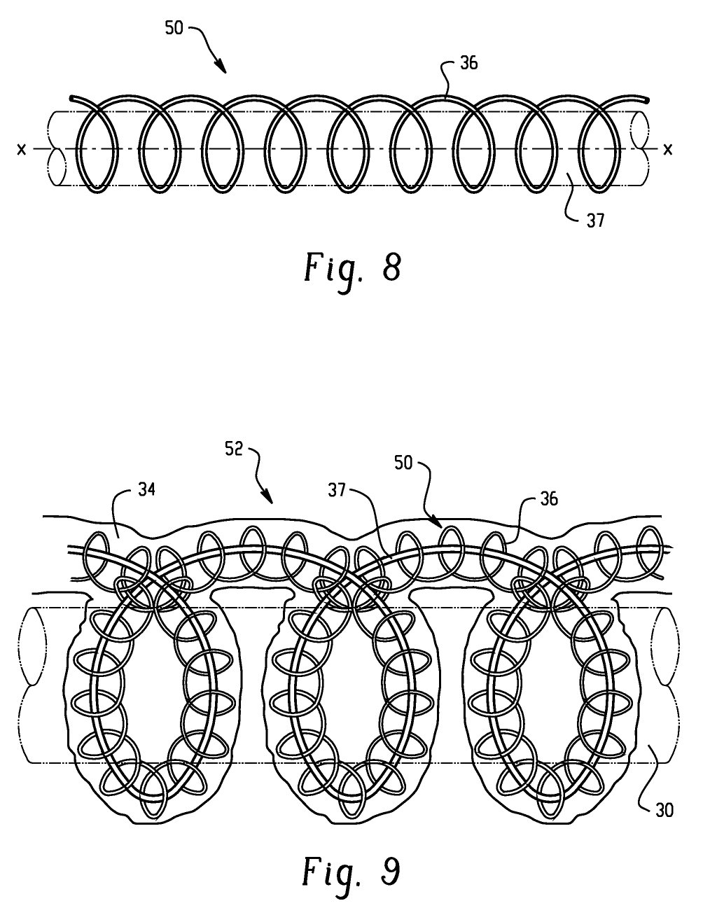

The coiled coil electrodes 6A, 6B have a coiled coil geometry which may be formed as illustrated in FIGS. 8 and 9. A primary coil structure 50 is first formed by winding a length of tungsten overwind wire 36 around a length of tungsten base wire 37 which determines the width of each turn of the coil and hence the primary coil diameter (FIG. 8). The primary coil structure 50 thus formed is then coiled around the electrode shank 30 to produce a secondary coil structure 52, as shown in FIG. 9. While FIG. 9 shows only a single (rather loose) winding of the secondary coil structure 52, it is to be appreciated that the secondary coil may have inner and outer winding 38, 39, as illustrated in FIG. 3. The resulting coiled coil electrode may be annealed at a suitable annealing temperature (e.g., about 1150° C.) to secure the wires together, without appreciably the altering electrode structure.

The secondary coil 52 contacts the shank and thus has an inner diameter defined by the shank diameter. The secondary coil has an overall length L, when formed, of about 2-5 mm, e.g., about 3 mm. As shown in FIG. 3, the outer winding 39 may have a slightly shorter length than the inner winding 38. The shank 30 may have a diameter d₅ of at least about 0.5 mm, e.g., about 0.7 mm and extend about 0.5-1 mm, or more, beyond the coiled coil 32 to define an electrode tip 46.

The exemplary wires 36, 37 and shank 30 are formed of tungsten. In general, they are formed predominantly from tungsten, i.e., at least 70% tungsten and generally a high purity tungsten, such as at least 99% tungsten. However, other electrically conductive materials which are stable in the arc are also contemplated.

The emitter material 34 can be applied to the coiled coil 32 in the form of a powder or slurry comprising carbonates of the desired oxides and converted in situ to the respective oxides. In order to make a slurry which will be used to coat the lamp coils, the mixed carbonate powder is combined with a liquid medium. The liquid medium may be similar to that used in lacquers and consists of an organic solvent, such as butyl acetate, or other low molecular weight acetate, and nitrocellulose, which is used as a thickener and binder. Other ingredients, such as alcohol, may also be added to achieve the desired viscosity. For example, the powdered carbonates, optionally with a relatively small amount of the liquid medium, are added to a mixer and the electrode 6A, 6B shaken in the mixture.

Exemplary shank and coil thicknesses for lamps of different wattages are given in TABLE 1:

TABLE 1

| | Lamp wattage | | |
|---|---|---|---|
| | 50 | 70 | 100 |
| Electrode shank diameter (d₅) in mm | 0.65 | 0.65 | 0.65 |
| Electrode coiled thickness (t) in mm | 0.30 | 0.30 | 0.30 |

The exemplary electrode finds particular application in high pressure sodium/mercury lamps of 35-100 W, as well as in mercury-free high pressure sodium lamps.

In one embodiment, lumen efficacy is increased by at least about 5% at 8000 hrs., as compared with a conventional double coil lamp, due to reduced end blackening and electrode loss. This may allow an improved lumen rating for the lamp.

The lamp may have higher reliability due to a low voltage rise. For example, the exemplary lamp may have a total voltage rise of about 5V at 14,000 hr, which compares favorably with existing lamps which may have a voltage rise of about 2.5V/1000 hr.

Published lumen maintenance curves of conventional lower wattage types (50-100 W IEC types) are lower than the high wattage range for all main HPS lamp manufacturers. In various aspects, the exemplary lamp may have the same high lumen maintenance rating for the low wattage range (below about 100 W, e.g., 50 W and 70 W IEC lamps) as for lamps of higher wattage.

The electrode 6A, 6B finds application in high pressure sodium discharge lamps, such as 50/85; 70/90; 100/100 W (standard and XO) and also in 35/52; 50/52; and 70/52 lamp types as well as for higher wattage lamps (note that the first number in each pair represents the wattage and the second number the lamp voltage).

Exemplary lamp characteristics for lamps formed according to the exemplary embodiment are as follows in TABLE 2.

TABLE 2

| | | |
|---|---|---|
| Lamp type (W) | 50-70 | 100 |
| Electric field strength (V/mm) | 2.4 | 2.2 |
| Wall load (W/cm2) | 15.9 | 16.4 |
| Arc length (mm) g | 35 | 43 |
| Mo-end backspace (mm) | 8.6 | 8.2 |
| Hotter-end backspace (mm) MK | 7.2 | 7.2 |
| Mo-end hotter-end backspace difference (mm) | 1.4 | 1 |

### Lamp Design Considerations:

The arc tube end blackening: this is created by the sputtered and/or the evaporated electrode material (emitter material, tungsten) on the inner wall surface of the arc tube around the electrode tip and coil body.

Electrode sputtering: electrode and e-mix material removal generally occurs due to the impact of the positively charged ions during the transients of the starting process until the stabilization of the arc discharge, and to a lesser extent, during steady state lamp operation. The bigger electrode size and improper e-mix can enhance the sputtering, optimized electrode geometry and e-mix type and amount can reduce it.

Electrode evaporation: electrode and e-mix material evaporate due to the operating temperature of the electrode tip and coil body. The evaporation rate for smaller electrodes is generally higher than for larger diameter electrodes.

The blackening rate can be reduced by the increased active surface area of the emitter material on the electrode, higher fill pressure of the arc tube, by choice of electrode geometry and size, and by choice of emitter material type and quality.

One problem in existing electrodes is that the electrode scaling rule limits the volume of the emission reservoir at lower wattages (e.g., 35-100 W), which tends to limit lamp life. Over time, the emitter material is typically lost, resulting in lower lumen maintenance. In the exemplary embodiment, this limitation can be overcome by using a coiled coil design of smaller diameter wire on the electrode winding which allows a sufficient weight of emission material to be retained, at least over the lamp life.

Without intending to limit the scope of the exemplary embodiment, the following examples demonstrate the effectiveness of the exemplary lamp design.

### EXAMPLES

Electrodes were formed as illustrated in FIG. 3 according to Table 3 by winding a tungsten overwind wire 36 around a base tungsten wire 37 and winding the resulting primary coil 50 on a tungsten electrode shank to form a secondary coil structure 52 having two overlapping layers 38, 39 of coil. The electrode had an overall length E of 5.5 mm and a tip length (shank extending beyond the coiled coil) of 0.8 mm. Other dimensions were as follows: L=2.8 mm, L′=2.6 mm, d₃=0.01748 mm, d₅=0.70 mm, θ=<1.5°. The coiled coil 32 was then annealed and coated with an emitter material (barium calcium tungstate). The amount of emitter material was about 3 mg after sintering.

Lamps were formed with a pair of the thus-formed electrodes in a Lucalox™ monolithic arc tube 2 comprising a fill of mercury/sodium amalgam (17% by weight Na, 12 mg Na) and a xenon starting gas (30 mbar and 250 mbar fill pressure) in accordance with FIG. 2. The lamps were designed for nominal operation at 70 watts (IEC).

TABLE 3
MATERIALS

| | TUNGSTEN | TUNGSTEN | | |
|---|---|---|---|---|
| | Overwind wire | Base Wire | SHANK | SECONDARY coil |
| WEIGHT [mg/200 mm] | About 3.6 | About 33.8 | 1482 | |
| DIAMETER [mm] | 0.0346 | 0.1056 | 0.70 ± 0.0126 | φ 0.66 ± 0.01 |
| CODE No. | 01040752 | 01099650 | 01114479 | 01165890 |
| TOTAL LENGTH [mm] | 792.4 | 108.9 | 5.5 | |

| | | | | ANNEALING |
|---|---|---|---|---|
| COILING DATA | | | | 1150° C.-3.2 m/p-tH₂ |
| | Primary coil | INNER layer | OUTER layer | 1150° C.-5p-tH₂ |
| PITCH | 1/16.53 | 1/5.72 | 1/5.72 | |
| TPI (turns per inch) | — | 145.29 | 145.29 | |
| TURNS | 1799 | 15 right | 14 left | |
| GAP LENGTH [mm] | — | 9-9 | — | |
| COIL LENGTH [mm] | — | 2.8 | ~2.6 | |

FINISHED SPECIFICATIONS

| | INNER | OUTER |
|---|---|---|
| TOTAL LENGTH [mm] | — | — |
| COIL LENGTH [mm] | 2.8 ± 0.3 | ~2.6 |
| OUTER DIAMETER [mm] | 1.0096 | ~1.36 |
| MANDREL RATIO | 3.78 | 5.78 |
| PITCH RATIO | 1.00 | 1.00 |
| WEIGHT (THEORETICAL) [mg] | — | 50.91 |

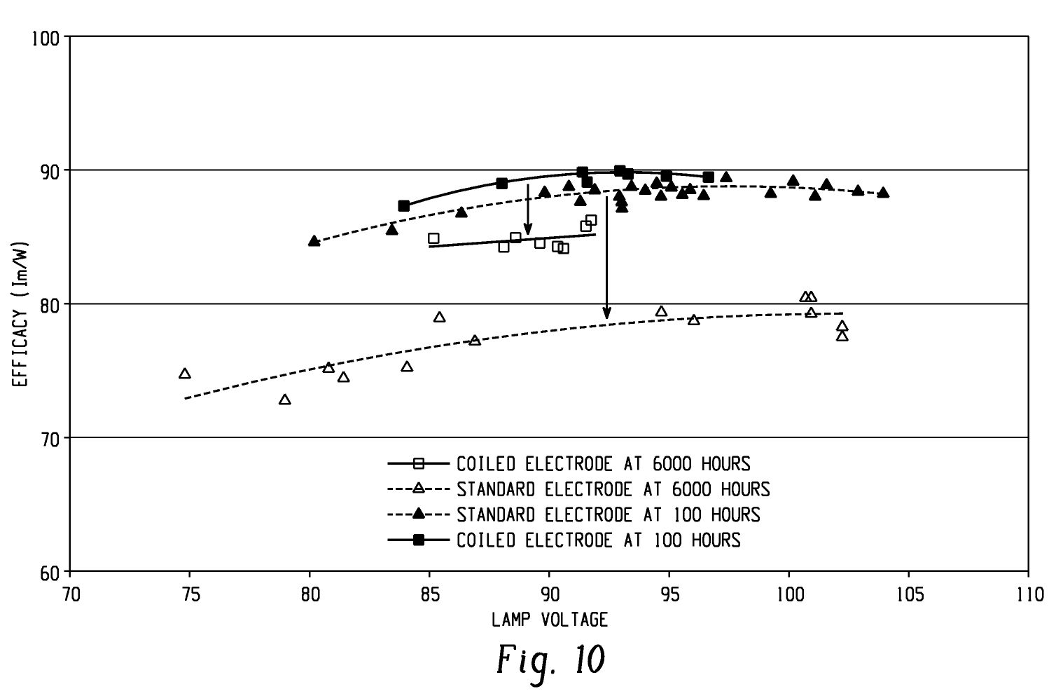

FIG. 10 shows the lumen output of the lamps thus formed over a range of operating voltages after constant operation for 6000 hrs. The exemplary coiled coil lamps at 30 mbar fill pressure (squares) had a higher lumen output than a comparable lamp (triangles) at equivalent burning voltage. The exemplary lamps were formed with the same coil length as the standard double coil electrode design.

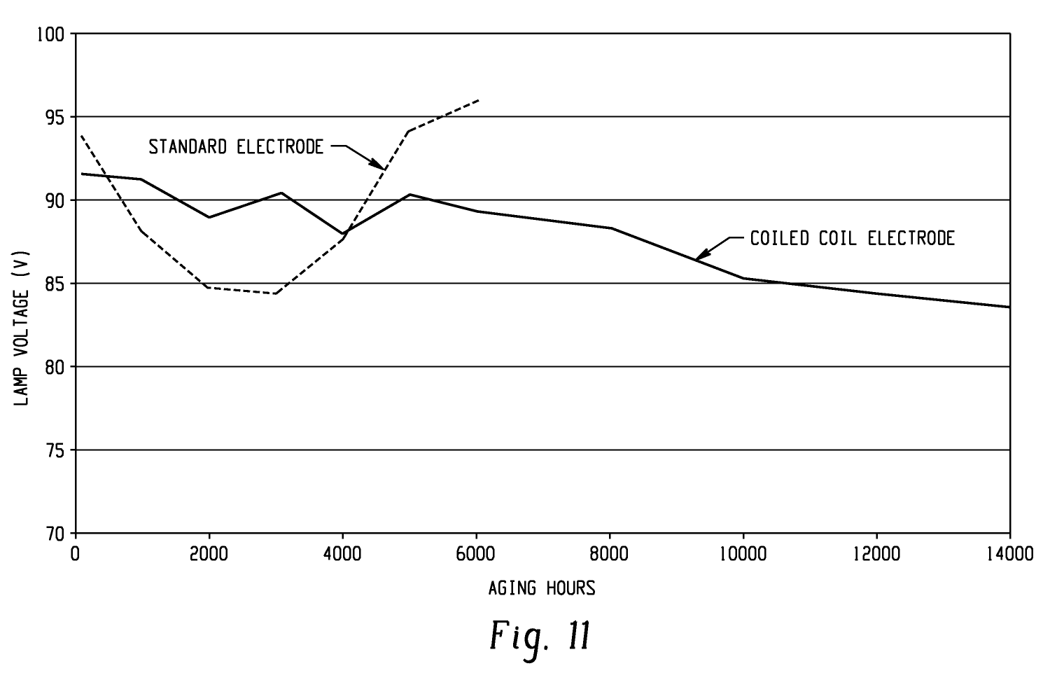

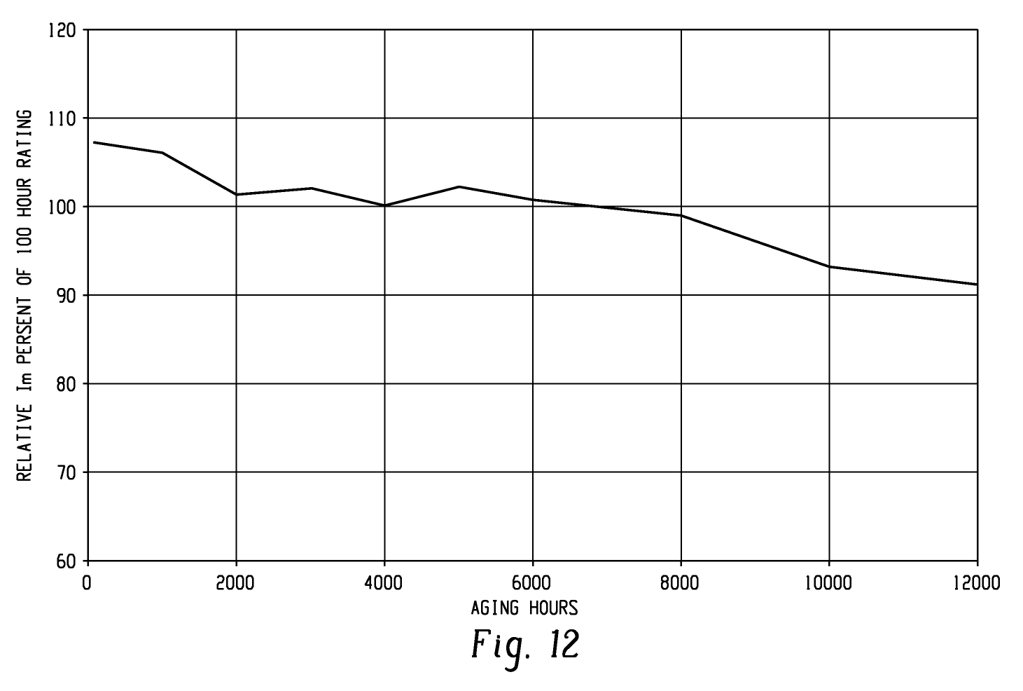

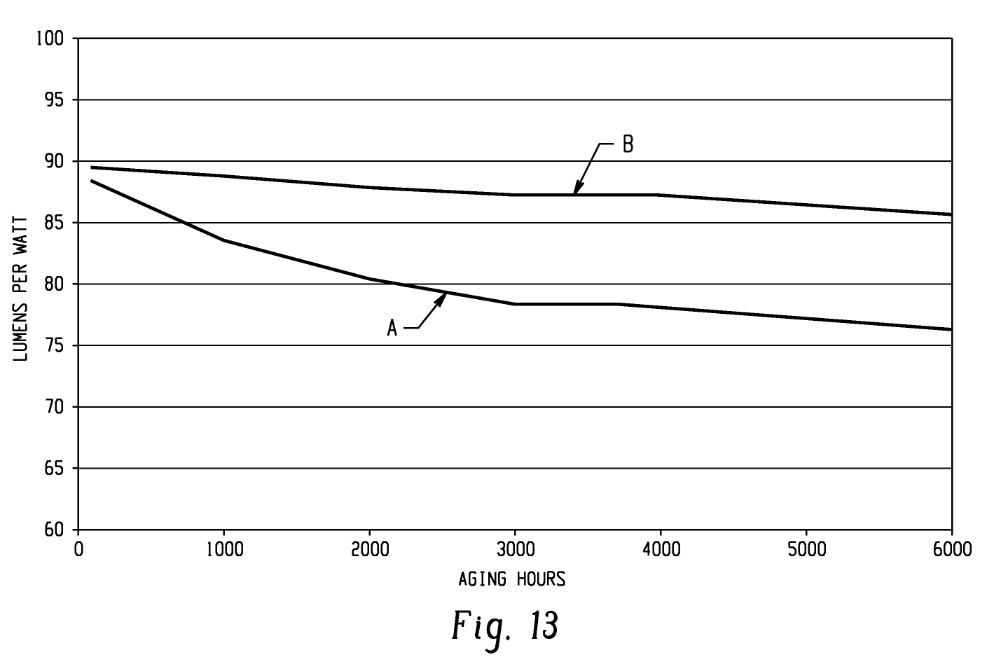

FIG. 11 shows the burning voltage over 14000 hrs. for ten exemplary lamps at 30 mbar cold fill pressure and for comparative lamps over 6000 hrs. As can be seen, the exemplary lamps have stable BV maintenance over 14000 hrs. FIG. 12 shows exemplary lumen maintenance values (lumens as a percentage of that at 100 hrs) for the exemplary lamp with the coiled coil over a 12000 hr test. The exemplary lamps have excellent lumen maintenance, approximately 10% higher 1 m/W at 6000 hrs. than the standard double coil electrode design. FIG. 13 shows lumens/watt over time for the comparative 70 watt lamp with a standard double coiled electrode (curve A) and the 70 watt lamp according to the exemplary embodiment (curve B).

### Advantages of the Coiled Coil Design

As shown in the results above with the coiled coil electrode design, the lamps formed have excellent BV and lumen maintenance performance over the test periods. Other advantages of the coiled coil design may be as follows: The lighter coil body, as compared with the comparable double coil lamp with the same amount of emitter, provides improved initial 1 m/W (efficiency) due to the reduced end losses. Improved lumen maintenance (approx. loss is about 1%/1000 hrs.) due to the lower blackening rate. Lower backspace (MK) sensitivity makes the arc tube less sensitive to the production variations. The reduced heat radiation from the electrode and the dominating arc heat stabilizes Tc. The smaller, lighter coil body can include the same e-mix amount as the standard electrode with lower variance. Better lumen maintenance (over 8000 hrs.) due to the lower blackening. Allows optimized arc tube geometry (bore size and wall thickness).

The invention has been described with reference to the preferred embodiments. Obviously, modifications and alterations will occur to others upon reading and understanding the preceding detailed description. It is intended that the invention be construed as including all such modifications and alterations.

What is claimed is:

1. A high pressure sodium discharge lamp comprising:
an arc tube which encloses a discharge sustaining fill which comprises sodium;
electrodes extending into the fill for generating an arc discharge in the fill during operation of the lamp, at least one of the electrodes comprising a coiled coil which supports an emitter material thereon.

2. The high pressure discharge lamp of claim 1, wherein the coiled coil includes a first coil structure and a second coil structure formed by coiling the first coil structure.

3. The high pressure discharge lamp of claim 2, wherein the first coil structure comprises a base wire with an overwind wire coiled around it.

4. The high pressure discharge lamp of claim 1, wherein the electrode includes a shank, the coiled coil encircling the shank.

5. The high pressure discharge lamp of claim 4, wherein the coiled coil includes a first coil structure and a second coil structure formed by coiling the first coil structure around the shank, the second coil structure forming at least ten turns around the shank.

6. The high pressure discharge lamp of claim 1, wherein the fill comprises sodium and an inert gas.

7. The high pressure discharge lamp of claim 6, wherein the fill further comprises mercury.

8. The high pressure discharge lamp of claim 6, wherein the inert gas comprises xenon.

9. The high pressure discharge lamp of claim 6, wherein the inert gas has a cold fill pressure of at least 20 torr.

10. The high pressure discharge lamp of claim 1, wherein the coiled coil is formed predominantly of tungsten.

11. The high pressure discharge lamp of claim 4, wherein the shank is formed predominantly of tungsten.

12. The high pressure discharge lamp of claim 4, wherein each electrode includes a shank which extends generally axially in the arc tube to define an arc gap therebetween.

13. The high pressure discharge lamp of claim 1, wherein the electrodes are spaced by an arc gap of less than 70 mm.

14. The high pressure discharge lamp of claim 1, wherein both of the electrodes comprise a coiled coil which supports an emitter material thereon.

15. The high pressure discharge lamp of claim 1, wherein the arc tube is a monolithic arc tube.

16. The high pressure discharge lamp of claim 1, wherein the sodium forms a pool at a cold spot of the arc tube.

17. The high pressure discharge lamp of claim 16, wherein the coiled coil has a diameter such that the cold spot is a direct line of travel for light from the arc.

18. The high pressure discharge lamp of claim 1, wherein the arc tube is formed predominantly of alumina.

19. The high pressure discharge lamp of claim 1, wherein the lamp has an operating wattage of less than 250 W.

20. The high pressure discharge lamp of claim 19, wherein the lamp has an operating wattage of up to 100 W.

21. A method of forming a high pressure discharge lamp comprising:
forming a first coil structure of an electrode by coiling an overwind wire around a base wire;
forming a second coil structure of the electrode by coiling the first coil structure around a shank;
coating the electrode with an emitter material;
inserting the electrode with a second electrode into an arc tube; and
sealing a discharge sustaining fill comprising sodium in the arc tube.

22. An electrode comprising:
a cylindrical tungsten shank having a diameter of 0.5-2 mm for coupling with a current source;
a coiled coil is provided on the tungsten shank, the coiled coil having a first coil structure formed by coiling an electrically conductive overwind wire around a base wire and a second coil structure formed by coiling the first coil structure around the shank; and
an emitter material supported on the coiled coil.
